(19) United States
(12) Patent Application Publication
(10) Pub. No.: US 2016/0078453 A1
(43) Pub. Date: Mar. 17, 2016

(54) Determining Groups of Individuals Based on Multiple Items of Individual Transaction Data

(71) Applicant: International Business Machines Corporation, Armonk, NY (US)

(72) Inventors: Priyanka Agrawal, Bangalore (IN); Indrajit Bhattacharya, Bangalore (IN); Raghuram Krishnapuram, Elmsford, NY (US)

(21) Appl. No.: 14/486,189

(22) Filed: Sep. 15, 2014

(51) Int. Cl. G06Q 30/02

(52) U.S. Cl. CPC G06Q 30/0201

(57) ABSTRACT

Methods, systems, and computer program products for determining groups of individuals based on multiple items of individual transaction data are provided herein. A method includes initializing a customer segment value for each of multiple purchased items identified in a purchase record based on one or more historical purchasing patterns; updating the customer segment value for each of the multiple purchased items based on the customer segment values for the other purchased items identified in the purchase record; and determining a customer segment composition of a group of individuals associated with the multiple purchased items identified in the purchase record based on the updated customer segment values.

### FIELD OF THE INVENTION

Embodiments of the invention generally relate to information technology, and, more particularly, to data segmentation techniques.

### BACKGROUND

Customers often purchase goods and services not just for themselves, but for family members as well. Purchase records, therefore, can often reflect the aggregate of the needs, habits and requirements of an entire family, and knowing the composition of a family and the family's needs and habits enables more accurate personalization for the family. Recommendations can be made if the family composition associated with an individual purchaser is known, but such a determination derived solely from the individual purchaser's purchases faces challenges under existing segmentation approaches.

Discovered segments can be interpretable for a model which recognizes that each basket corresponds to a mixture over segments. As used herein, a basket refers to a collection or a set of items in a retail setting. For such a model, a discovered segment can include, for example, (male, PhD, middle aged). For a model that associates a single segment with a basket, an example segment might include [0.2(male, PhD, middle aged)+0.3(female, college graduate, middle aged)+0.3(male, high school graduate, teenager)+ . . . ].

Learning family purchase habits of segments is more challenging statistically when the family structure is not recognized. By way merely of example, assume that there are six people in an example family structure, each of whom can belong to four different segments, and each of whom may or may not be geographically present in a given family. With such an example framework, 5⁶=15625 segments can be obtained for one particular case wherein the family structure is not recognized, and 4*6=24 segments can be obtained for another particular case wherein a family structure is recognized. In this example, the first case refers to a scenario wherein the segments for the family members are not taken into account, and the second case refers to a scenario wherein the segments are taken into account. Given a finite amount of data, having significantly fewer parameters to learn will likely result in a significantly higher level of confidence on the estimated values (or posterior distributions) of such parameters.

Accordingly, a need exists for techniques to determine associated groups of individuals based on multiple items of individual transaction data.

### SUMMARY

In one aspect of the present invention, techniques for determining groups of individuals based on multiple items of individual transaction data are provided. An exemplary computer-implemented method can include steps of initializing a customer segment value for each of multiple purchased items identified in a purchase record based on one or more historical purchasing patterns; updating the customer segment value for each of the multiple purchased items based on the customer segment values for the other purchased items identified in the purchase record; and determining a customer segment composition of a group of individuals associated with the multiple purchased items identified in the purchase record based on the updated customer segment values.

In another aspect of the invention, an exemplary computer-implemented method can include steps of initializing an item category for each of multiple purchased items identified in a purchase record; initializing a customer segment value for each of the multiple purchased items identified in the purchase record based on one or more historical purchasing patterns; and updating the customer segment value for each of the multiple purchased items based on (i) the customer segment values for the other purchased items identified in the purchase record and (ii) the item categories initialized for the other purchased items identified in the purchase record. The method also includes updating the item category for each of the multiple purchased items based on (i) the customer segment values for the other purchased items identified in the purchase record and (ii) the item categories initialized for the other purchased items identified in the purchase record; and determining the customer segment composition of a group of individuals associated with the multiple purchased items identified in the purchase record based on (i) the updated customer segment values and (ii) the updated item categories.

In yet another aspect of the invention, an exemplary computer-implemented method can include steps of initializing an item category for each of multiple purchased items identified in a purchase record; initializing a customer segment value for each of the multiple purchased items identified in the purchase record based on one or more historical purchasing patterns; and updating the customer segment value for each of the multiple purchased items based on (i) a customer identifier for the purchase record, (ii) the customer segment values for the other purchased items identified in the purchase record, and (iii) the item categories initialized for the other purchased items identified in the purchase record. The method also includes updating the item category for each of the multiple purchased items based on (i) the customer segment values for the other purchased items identified in the purchase record and (ii) the item categories initialized for the other purchased items identified in the purchase record; and determining the customer segment composition of a group of individuals associated with the multiple purchased items identified in the purchase record based on (i) the customer identifier for the purchase record, (ii) the updated customer segment values and (iii) the updated item categories.

Further, in another aspect of the invention, an exemplary computer-implemented method can include steps of initializing an item category for each of multiple purchased items identified in a purchase record; initializing a customer identifier for the purchase record; and determining a network of additional customers associated with the customer identifier initialized for the purchase record based on one or more parameters. The method also includes generating a distribution estimate over multiple customer segments for multiple item categories across multiple additional purchase records for the customer identifier by randomly sampling one or more of the additional customers in the network; and determining a customer segment composition of a group of individuals associated with the customer identifier based on (i) the purchase record and (ii) the distribution estimate.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example segment model, according to an embodiment of the invention;

FIG. 2 is a diagram illustrating an example segment and category model, according to an embodiment of the invention;

FIG. 3 is a diagram illustrating an example segment, category, and customer identification model, according to an embodiment of the invention;

FIG. 4 is a diagram illustrating an example segment, category, customer identification and network model, according to an embodiment of the invention;

FIG. 5 is a flow diagram illustrating techniques according to an embodiment of the invention; and

FIG. 6 is a system diagram of an exemplary computer system on which at least one embodiment of the invention can be implemented.

### DETAILED DESCRIPTION

As described herein, an aspect of the present invention includes discovering virtual families from purchase records. As used herein, the term “family” is used in a general sense to refer to a group of individuals who frequently transact as a group. One example embodiment of the invention can be carried out within the context of a traditional family unit, while one or more other embodiments of the invention can be carried out within additional contexts that can include, for instance, a group of friends who frequently shop together and/or for one another. Accordingly, one or more embodiments of the invention include determining groups of individuals based on multiple items of individual transaction data.

At least one embodiment of the invention includes inferring segments of multiple hidden customers associated with given purchase records (that is, purchase records not explicitly linked to the hidden customers). Accordingly, one or more embodiments of the invention include utilizing one or more of (i) customer segment data, (ii) purchase records, (iii) item categories, (iv) customer identifiers (IDs) associated with purchases, and (v) customer/buyer network data to associate each item of a purchase with a particular segment. Further, such embodiments can also include iterating over each item in each purchase record to determine a virtual family associated with the purchase, wherein iterating can include updating the segment and category distributions based on current segments and categories of all other items and/or current segment and category distributions making use of the customer IDs and the customer's social network.

By way of illustration, an example embodiment of the invention can include the following determination. Given T customer segments, N purchase records, K item categories, a customer ID for each purchase, and a network of buyers, an example embodiment of the invention can include associating, for each purchase item for each of the N purchase records, the segment (of the customer) for whom the item was purchased. Additionally, such an embodiment further includes aggregating and thresholding the segment counts to provide a profile of the virtual family associated with the purchase record. By way of example, aggregating can include counting the total number of items assigned to a specific segment. Additionally, thresholding can be performed, for example, by selecting all segments that have assignment counts above a specific value.

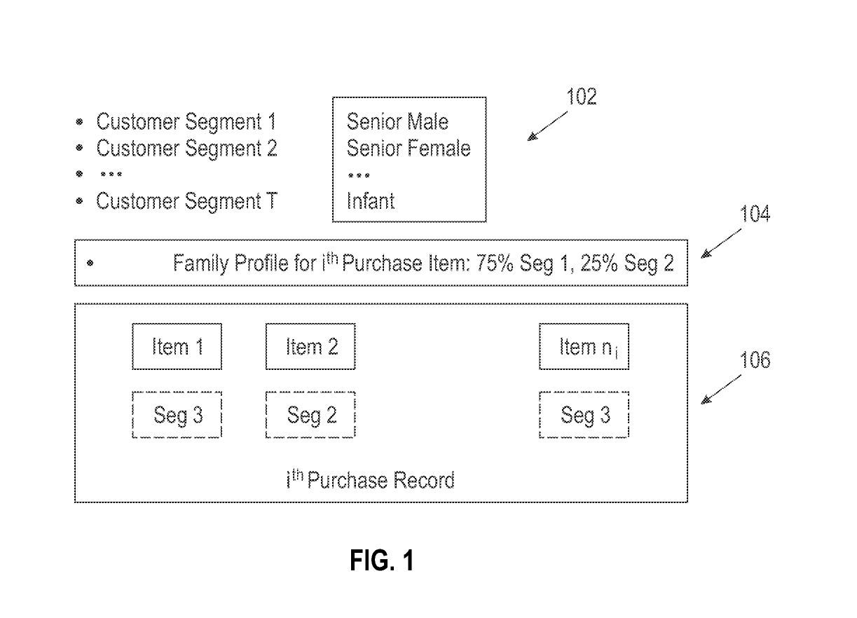

FIG. 1 is a diagram illustrating an example segment model, according to an embodiment of the invention. By way of illustration, FIG. 1 depicts an identification of customer segments 102, a family profile 104 for a given purchase item (which, as detailed in FIG. 1 is the i^{th} purchase item and includes a distribution of 75% attributed to customer segment 1 and 25% attributed to customer segment 2), and a purchase record 106 (the i^{th} purchase record, in FIG. 1). The purchase record 106 includes an association of each item in the purchase record to the customer segment determined to be associated with such a purchase based, for example, on patterns of co-occurrence of items in other purchase records.

Accordingly, the example embodiment of the invention illustrated in FIG. 1 is implemented within a setting wherein only customer segments and purchase records are available. Such an embodiment can include using the latent Dirichlet allocation (LDA) topic model to interpret words as purchase items, documents as purchase records and customer segments as topics. As noted above, in such a model, each customer segment has a distribution over purchase items, each purchase record has a distribution over customer segments, and each purchase item in a purchase record is generated by selecting one segment and an item from that selected segment. A segment is selected by sampling from the distribution over segments, and a purchase item is selected by sampling from the distribution over items for the specific segment selected.

Additionally, such an embodiment of the invention can include utilizing a probabilistic inference such as LDA to estimate a posterior probability of segments for each purchase record, as well as an associated segment for each item in each purchase record. In at least one embodiment of the invention, such distributions can be estimated through sampling procedures. For example, a sampling algorithm repeatedly samples the segment category for each purchase item, given the segments for all other items. When the sampling converges, the posterior distribution over segments for each purchase record is obtained by normalizing the occurrence counts of each segment over items in that record.

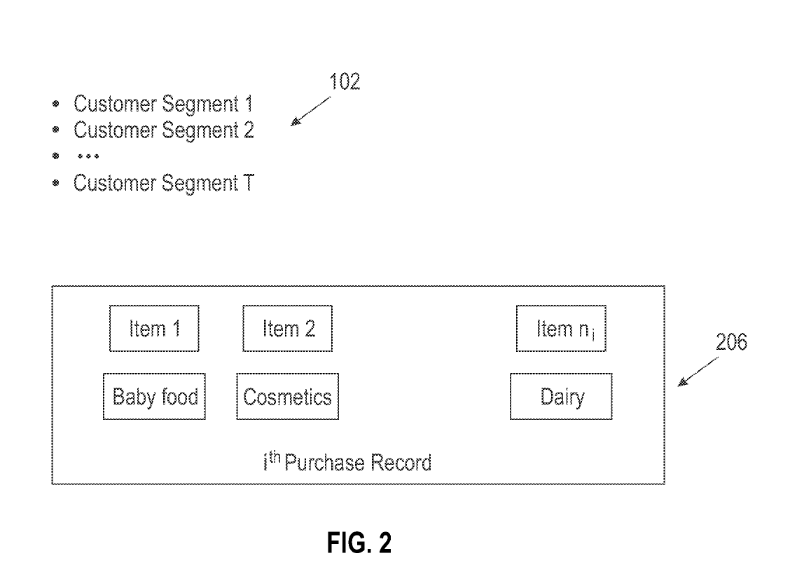

FIG. 2 is a diagram illustrating an example segment and category model, according to an embodiment of the invention. By way of illustration, FIG. 2 depicts an identification of customer segments 102 and a purchase record 206 (the i^{th} purchase record, for example) that includes item categories. For instance, purchase record 206 associates item 1 with the category of baby food, associates item 2 with the category of cosmetics, and associates item nᵢ with the category of dairy.

Using an implementation such as depicted in FIG. 2, at least one embodiment of the invention includes using an author topic model (ATM) to interpret words as purchase items, documents as purchase records, customer segments as authors, and item categories as topics. In such a model, each customer segment has a distribution over item categories, each item category has a distribution over purchase items, each purchase record has a distribution over customer segments, and each purchase item in a record is generated by selecting and/or sampling one segment, a category from that segment, and an item from that category.

Additionally, an embodiment of the invention implementing a model such as depicted in FIG. 2 can include modifying a probabilistic inference for ATM to learn the posterior probability of segments for each purchase record, and associating a segment (and a category) for each item in a purchase record. In such an embodiment, the modified version of the ATM inference algorithm iteratively samples the segment for each purchase item, given the category for that item and the segments and categories for all other purchase items. Additionally, the algorithm continues with such sampling steps until convergence. Such a modification can be carried out, for example, because the topic (category) for each word (item) is observed, but the authors (segments) for a document (purchase record) are unobserved.

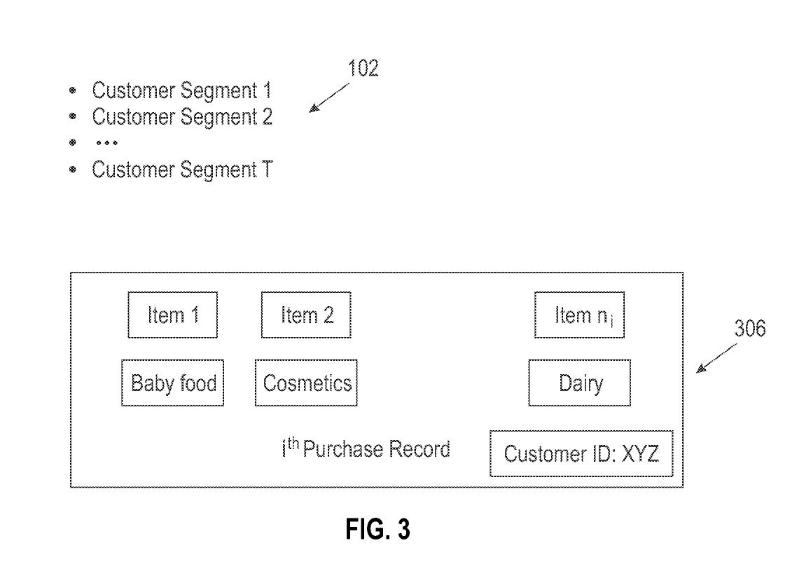

FIG. 3 is a diagram illustrating an example segment, category, and customer identification model, according to an embodiment of the invention. By way of illustration, FIG. 3 depicts an identification of customer segments 102, and a purchase record 306 (the i^{th} purchase record, for example) that includes item categories and a customer ID for each purchase. For instance, purchase record 306 associates item 1 with the category of baby food, associates item 2 with the category of cosmetics, and associates item nᵢ with the category of dairy, while the purchase record 306 identifies all purchases as being made by customer ID XYZ. Accordingly, based on this information, at least one embodiment of the invention includes building a family profile of a particular customer (customer ID XYZ, in this example) rather than a profile of a purchase.

Additionally, in connection with a model such as depicted in FIG. 3, an example embodiment of the invention can include assuming that deterministic mappings of customer profiles to segments labels as well as distributions over product categories are unknown. Accordingly, such an embodiment includes capturing knowledge that all purchase records with particular customer ID correspond to the same family or group. The above-noted “knowledge” includes an assumption that is always true. For instance, the same customer ID always refers to the same customer, and therefore to the same family.

Additionally, at least one embodiment of the invention can include modifying the model depicted in FIG. 2 (the segment-category model) so that the same distribution over customer segments is used for all purchase records with a particular customer ID. Also, a partially observed variant of the inference for the model depicted in FIG. 2 can be used, wherein one customer segment for each record is observed. Further, such an embodiment can also include biasing a sampling of segments for any purchase item in a record to favor the item's observed customer segment. A sampling of segments can also favor other segments used in purchase records with the same customer ID.

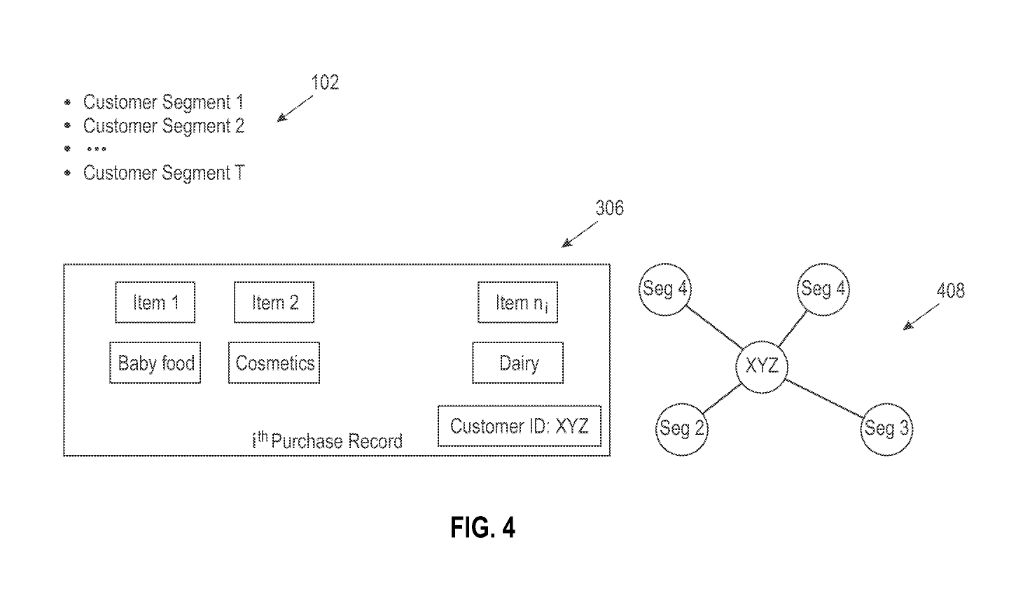

FIG. 4 is a diagram illustrating an example segment, category, customer identification and network model, according to an embodiment of the invention. By way of illustration, FIG. 4 depicts an identification of customer segments 102, a purchase record 306 (the i^{th} purchase record, for example) that includes item categories and a customer ID for each purchase, and a network of customers (or buyers) 408. Using a model such as depicted in FIG. 4, at least one embodiment of the invention can include utilizing knowledge of immediate neighbors of a customer in the network 408 to infer a virtual family. In at least one embodiment of the invention, the knowledge of immediate neighbors includes the identification of friends and/or followers of a user on a social media site. For example, many retail sites allow customers to log-in using a social network ID.

By way of example, at least one embodiment of the invention can include modifying the model depicted in FIG. 3 such that the distribution over customer segments for each purchase record for a specific customer is constructed by randomly sampling the customer's neighbors in the network 408. Such a modification could result in a high probability of certain segments being in the virtual family of the given customer (customer ID XYZ, for example). In one or more embodiments of the invention, additional customer segments with lesser probability values can be included as well.

Further, at least one embodiment of the invention can include modifying the probabilistic inference associated with the model depicted in FIG. 3 to consider and/or incorporate the network 408. In such an embodiment, a sampling of segments additionally favors segments of specific customer network neighbors.

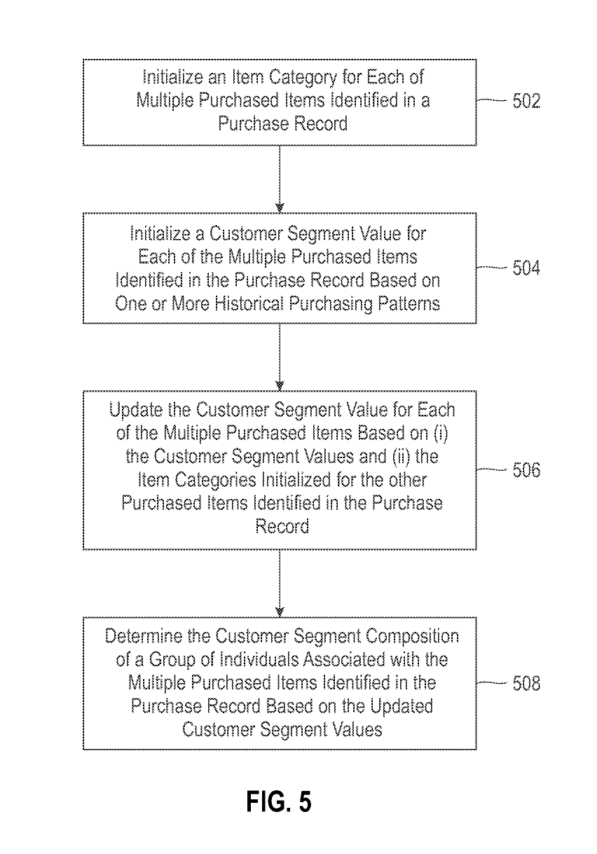

FIG. 5 is a flow diagram illustrating techniques according to an embodiment of the invention. Step 502 includes initializing an item category for each of multiple purchased items identified in a purchase record. Initializing the item category for each of the multiple purchased items can include determining a distribution of each item category over a set of multiple purchased items.

Step 504 includes initializing a customer segment value for each of the multiple purchased items identified in the purchase record based on one or more historical purchasing patterns. Initializing the customer segment value for each of the multiple purchased items can include determining a distribution of each customer segment over multiple item categories. Additionally, in such an embodiment of the invention, updating can include updating the distribution of each customer segment over the multiple item categories based on (i) the customer segment values for the other purchased items identified in the purchase record and (ii) the item categories initialized for the other purchased items identified in the purchase record.

Additionally, as detailed herein, a customer segment value can include, for example, a consideration of customer age, customer gender, customer education level, etc.

Step 506 includes updating the customer segment value for each of the multiple purchased items based on (i) the customer segment values for the other purchased items identified in the purchase record and (ii) the item categories initialized for the other purchased items identified in the purchase record.

Step 508 includes determining a customer segment composition of a group of individuals associated with the multiple purchased items identified in the purchase record based on the updated customer segment values. Determining can include determining a customer segment distribution across the multiple purchased items identified in the purchase record based on the updated customer segment values. Determining can also include aggregating and thresholding the updated customer segment values to generate a profile of said group of individuals.

The group of individuals associated with the multiple purchases items identified in the purchase record is not identified in the purchase record. Additionally, the group can include, for example, a family unit, a collection of unrelated individuals, or a combination thereof.

Also, at least one embodiment of the invention includes steps of initializing an item category for each of multiple purchased items identified in a purchase record, initializing a customer identifier for the purchase record, and determining a network of additional customers associated with the customer identifier initialized for the purchase record based on one or more parameters. Such an embodiment further includes the steps of generating a distribution estimate over multiple customer segments for multiple item categories across multiple additional purchase records for the customer identifier by randomly sampling one or more of the additional customers in the network, and determining the customer segment composition of a group of individuals associated with the customer identifier based on (i) the purchase record and (ii) the distribution estimate.

In such an embodiment, the network can be derived, for example, from a social network associated with the customer identifier. Also, similar to the embodiments detailed above in connection with FIG. 4, the group of individuals associated with the customer identifier is not identified in the purchase record, and the group can include a family unit, a collection of unrelated individuals, or a combination thereof.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

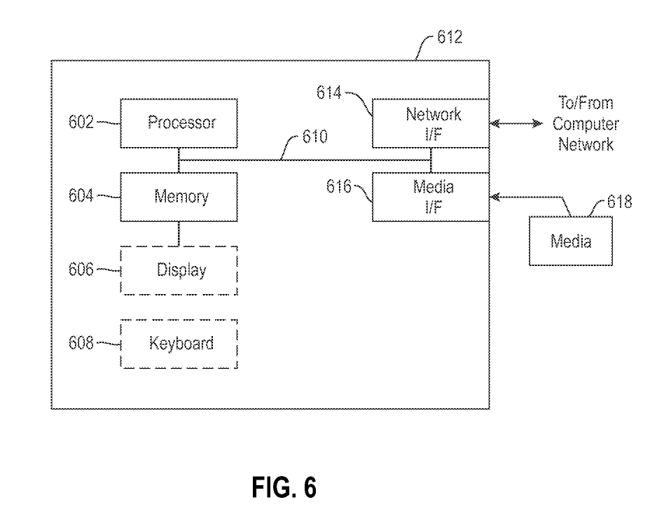

Additionally, an aspect of the present invention can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, analyzing each item in a purchase record to determine the virtual family associated with the purchase.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising the following steps:
initializing a customer segment value for each of multiple purchased items identified in a purchase record based on one or more historical purchasing patterns;
updating the customer segment value for each of the multiple purchased items based on the customer segment values for each other purchased item identified in the purchase record; and
determining a customer segment composition of a group of individuals associated with the multiple purchased items identified in the purchase record based on the updated customer segment values;
wherein at least one of the steps is carried out by a computing device.

2. The method of claim 1, wherein said initializing the customer segment value for each of the multiple purchased items comprises determining a distribution of each customer segment over multiple item categories.

3. The method of claim 1, wherein said group of individuals associated with the multiple purchases items identified in the purchase record is not identified in the purchase record.

4. The method of claim 1, wherein said determining comprises determining a customer segment distribution across the multiple purchased items identified in the purchase record based on the updated customer segment values.

5. The method of claim 1, wherein said determining comprises aggregating and thresholding the updated customer segment values to generate a profile of said group of individuals.

6. A method comprising the following steps:
initializing an item category for each of multiple purchased items identified in a purchase record;
initializing a customer segment value for each of the multiple purchased items identified in the purchase record based on one or more historical purchasing patterns;
updating the customer segment value for each of the multiple purchased items based on (i) the customer segment values for each other purchased item identified in the purchase record and (ii) the item categories initialized for the other purchased items identified in the purchase record;
updating the item category for each of the multiple purchased items based on (i) the customer segment values for the other purchased items identified in the purchase record and (ii) the item categories initialized for the other purchased items identified in the purchase record; and
determining a customer segment composition of a group of individuals associated with the multiple purchased items identified in the purchase record based on (i) the updated customer segment values and (ii) the updated item categories;
wherein at least one of the steps is carried out by a computing device.

7. The method of claim 6, wherein said initializing the customer segment value for each of the multiple purchased items comprises determining a distribution of each customer segment over multiple item categories.

8. The method of claim 7, wherein said updating the customer segment value comprises updating the distribution of each customer segment over the multiple item categories based on (i) the customer segment values for the other purchased items identified in the purchase record and (ii) the item categories initialized for the other purchased items identified in the purchase record.

9. The method of claim 6, wherein said initializing the item category for each of the multiple purchased items comprises determining a distribution of each item category over a set of multiple purchased items.

10. The method of claim 6, wherein said group of individuals associated with the multiple purchases items identified in the purchase record is not identified in the purchase record.

11. The method of claim 6, wherein said determining comprises aggregating and thresholding the updated customer segment values to generate a profile of said group of individuals.

12. A method comprising the following steps:
initializing an item category for each of multiple purchased items identified in a purchase record;
initializing a customer segment value for each of the multiple purchased items identified in the purchase record based on one or more historical purchasing patterns;
updating the customer segment value for each of the multiple purchased items based on (i) a customer identifier for the purchase record, (ii) the customer segment values for each other purchased item identified in the purchase record, and (iii) the item categories initialized for the other purchased items identified in the purchase record;
updating the item category for each of the multiple purchased items based on (i) the customer segment values for the other purchased items identified in the purchase record and (ii) the item categories initialized for the other purchased items identified in the purchase record; and
determining a customer segment composition of a group of individuals associated with the multiple purchased items identified in the purchase record based on (i) the customer identifier for the purchase record, (ii) the updated customer segment values and (iii) the updated item categories;
wherein at least one of the steps is carried out by a computing device.

13. The method of claim 12, wherein said determining comprises aggregating and thresholding the updated customer segment values to generate a profile of said group of individuals.

14. The method of claim 12, wherein said initializing the customer segment value for each of the multiple purchased items comprises determining a distribution of each customer segment over multiple item categories.

15. The method of claim 12, wherein said initializing the item category for each of the multiple purchased items comprises determining a distribution of each item category over a set of multiple purchased items.

16. The method of claim 12, wherein said group of individuals associated with the multiple purchases items identified in the purchase record is not identified in the purchase record.

17. A method comprising the following steps:
initializing an item category for each of multiple purchased items identified in a purchase record;
initializing a customer identifier for the purchase record;
determining a network of additional customers associated with the customer identifier initialized for the purchase record based on one or more parameters;
generating a distribution estimate over multiple customer segments for multiple item categories across multiple additional purchase records for the customer identifier by randomly sampling one or more of the additional customers in the network; and
determining a customer segment composition of a group of individuals associated with the customer identifier based on (i) the purchase record and (ii) the distribution estimate;
wherein at least one of the steps is carried out by a computing device.

18. The method of claim 17, wherein said network is derived from a social network associated with the customer identifier.

19. The method of claim 17, wherein said group of individuals associated with the customer identification is not identified in the purchase record.

20. The method of claim 17, wherein said determining the customer segment composition comprises aggregating and thresholding the updated customer segment values to generate a profile of said group of individuals.
